(19) United States
(12) Patent Application Publication
(10) Pub. No.: US 2025/0139686 A1
(43) Pub. Date: May 1, 2025

(54) Route Selection for Obtaining Items in a Warehouse

(71) Applicant: Maplebear Inc., San Francisco, CA (US)

(72) Inventors: Brent Scheibelhut, Toronto (CA); Shaun Navin Maharaj, Vaughan (CA); Mark Oberemk, Toronto (CA); Ryan Martin, Toronto (CA); Ryan McColeman, Toronto (CA)

(21) Appl. No.: 18/496,679

(22) Filed: Oct. 27, 2023

(51) Int. Cl. G06Q 30/0601

(52) U.S. Cl. CPC G06Q 30/0639; G06Q 30/0641

(57) ABSTRACT

Different possible candidate routes for efficiently obtaining a set of items at given retailer premises are generated and simulated to estimate degrees of difficulty of the various routes, such as how long they are expected to take. The current conditions can be inferred based on analysis of environment data received from a plurality of devices associated with users shopping for items on the retailer premises, such as location data, camera data, or comments related to the retailer premises. The simulation takes into account current or expected conditions in the environment of the retailer premises, such as obstructions, alternative placements of items, etc. Routes with least degrees of difficulty may be presented to the users shopping for the items so that the users can use the most efficient routes when obtaining the items.

### BACKGROUND

Customers of a physical store often wish to be able to obtain their items in an efficient manner that minimizes the time spent in obtaining those items, thereby obtaining their items with as little delay as possible. Likewise, shoppers who are paid by the job to obtain items on behalf of customers (e.g., obtaining a list of products from a grocery store), and who are enabled to earn more when they can reduce the amount of time required to complete the shopping, also wish to be able to obtain the items with maximal efficiency. Additionally, it is also in the interests of the retail locations (e.g., supermarkets) to make shopping efficient in order to reduce shopper congestion and increase their desirability as convenient shopping locations.

However, it can be complex for a shopper to determine an efficient route for obtaining all the items on the customer's shopping list. It typically takes considerable shopping experience-including intimate knowledge of the layout, item locations, and patterns of particular stores-before a shopper can fulfill a customer's order in a reasonably efficient manner. Even so, dynamically-changing conditions, such as the rearranging of item locations, or unusual traffic patterns, spills or other obstacles within stores, or the like, present additional obstacles to shoppers seeking to complete their shopping in an optimally-efficient manner.

### SUMMARY

In accordance with one or more aspects of the disclosure, different possible candidate routes for efficiently obtaining a set of items at given retailer premises are generated and simulated to estimate degrees of difficulty of the various routes, such as how long they are expected to take. The simulation takes into account current or expected conditions in the environment of the retailer premises, such as obstructions, alternative placements of items, etc. Routes with least degrees of difficulty may be presented to the users shopping for the items so that the users can use the most efficient routes when obtaining the items.

The current conditions can be inferred based on analysis of environment data received from a plurality of devices associated with users shopping for items on the retailer premises. For example, the environment data may include user-associated data with the user, such as location data, camera data, or comments related to the retailer premises expressly specified by the user.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates components of the shopping route module of FIG. 2, along with other systems and components that interact with it, according to some embodiments.

FIG. 4 is a data flow diagram illustrating the data, and transformations of data, involved in determining estimated degrees of difficulty (e.g., time estimates) of candidate routes, according to one or more embodiments.

FIG. 5 is a flowchart of steps for selecting optimized shopping routes, according to some embodiments.

### DETAILED DESCRIPTION

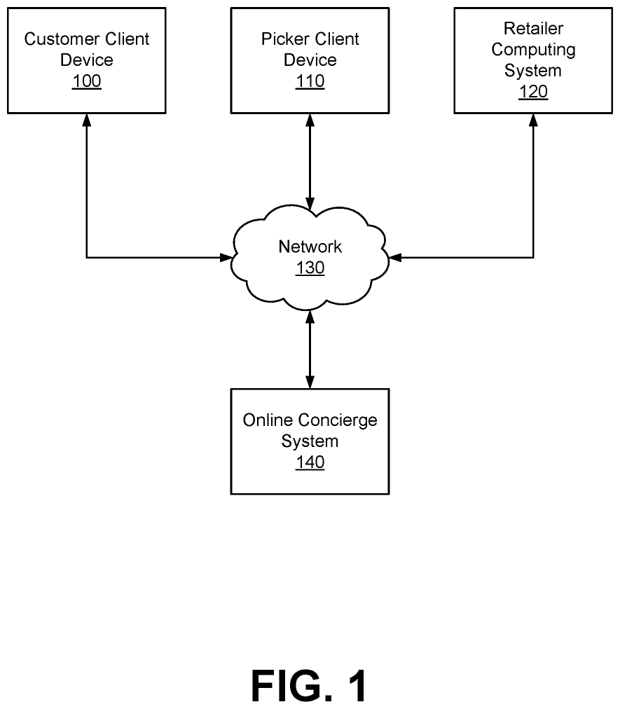

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered.

Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location” (also referred to as a “warehouse”), which is a store for retail shoppers an intermediate storage building to which items are shipped, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

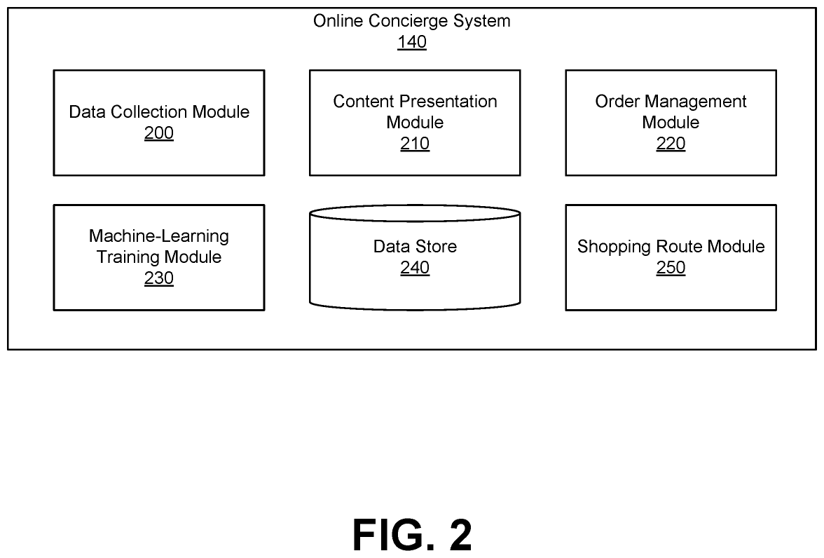

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The online concierge system 140 additionally includes a shopping route module 250 that determines optimized routes that pickers can use to obtain the items in the basket of a customer on behalf of whom they are shopping.

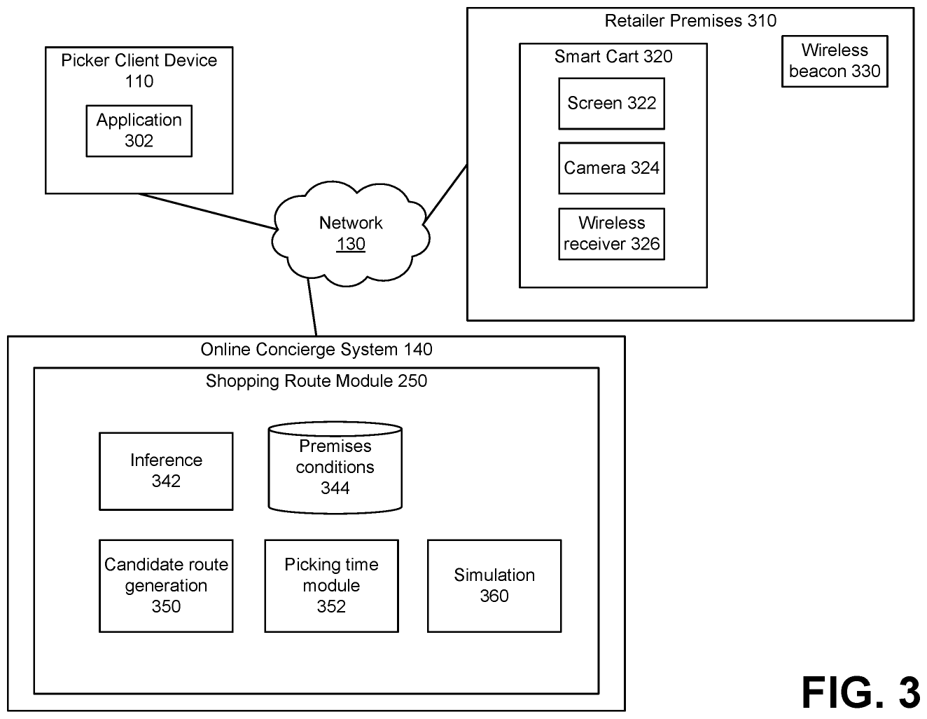

FIG. 3 illustrates components of the shopping route module 250 of FIG. 2, along with other systems and components that interact with it, according to some embodiments.

The picker client device 110 includes (in addition to the components discussed above with respect to FIG. 1) an application 302 enabling the user of the device (e.g., the picker) to interact with the online concierge system 140 when shopping. (Although the picker is described as the individual providing information via the application 302, a non-picker user, such as a customer, could do likewise.) Of particular relevance to the actions of the shopping route module 250, the application 302 (among its other features) permits the picker to specify information about the environment of the retailer premises 310 that may be of relevance to routing decisions when shopping for items at those premises 310. For example, the picker could use the application 302 to specify that there is a spill of liquids or other hazard, or an aisle blockage, at a particular spot that serves as an obstacle that impedes movement through that area. As another example, the picker could use the application 302 to specify that a particular item is now found in a particular location (e.g., a promotional display area), which provides alternate locations for pickers to obtain that item, thereby allowing additional possible shopping routes. The application 302 can relay all this specified information to the online concierge system 140, so that the shopping route module 250 may use it when making routing decisions.

The retailer premises 310 are the physical locations at which pickers may acquire items. The retailer premises 310, like the application 302 on the picker device 110, may provide additional information to the online concierge system 140 that the shopping route module 250 may use when making routing decisions. For example, some retailer premises 310 have smart carts 320 that pickers and other shoppers may use when shopping. The smart carts 320 are similar to traditional shopping carts but additionally have components that can assist the picker in efficiently obtaining items. For example, the smart carts 320 may have a screen 322 (e.g., an LCD panel) that provides information to the picker, such as maps of the store, store product databases, or the like. The smart carts may additionally and/or alternatively have a camera 324 that continuously obtains image data about its surroundings. The image data may then be provided as input to machine-learned image recognition models (either within the smart cart 320, or on another system, such as the picker client device 110, or the online concierge system 140) that identify objects and situations within the image data. For example, the image data could be used to automatically identify that bananas are available near the current location of the smart cart 320, that there is an obstruction in the aisle nearby, or the like. Additionally, the smart carts 320 may have the ability to provide location information. For example, the smart cart 320 may have a wireless receiver 326 that can be used to determine location information, such as with reference to a passive or active radio frequency identification device (RFID) tag, or one or more wireless beacons 330 of the retailer premises 310; in this way, the location of the smart cart 320 on which the receiver 326 is located (and, by extension, the location of the picker using the cart) can be determined. (The ability to determine location in this way can be very beneficial for retailer premises 310 for which other location information, such as GPS signals, is inconsistent or unavailable.) This additional information may be provided by the smart cart 320 to the online concierge system 140 either directly, or by first providing it to the application 302, which in turn relays it to the online concierge system.

The shopping route module 250 of the online concierge system 140 interacts with the picker client device 110 and/or smart cart 320 and has a number of components that work together to compute optimized shopping routes at the retailer premises 310 or perform related functions.

The shopping route module 250 includes an inference module 342 that receives data from the various picker client devices 110 and/or smart carts 320 in a “crowdsourced” manner to obtain information on many retailer premises 310 and locations within a single retailer premises. The inference module 342 makes inferences based on this raw input data to estimate the current conditions within the retailer premises 310 from which the data was received. For example, based on image data and location data, the inference module 342 might infer that a particular product is available at a particular location in the store (e.g., that bananas are available at a particular spot that is separate from the usual produce section), or that there is an obstruction in a particular place (e.g., that aisle 6 has been blocked off), or that checkout line 3 is particularly long, or the like. In this way, the information obtained from one picker or other user may be used to inform the decisions for other pickers/users.

The shopping route module 250 stores any conditions learned about particular retailer premises in a premises conditions repository 344. The conditions in the repository 344 may be learned based on the inferences of the inference module 342, upon environmental conditions explicitly specified by users via the application 302, or the like. In some embodiments, the shopping route module 250 adds entries to the premises conditions repository 344 only after a number of confirmations from the applications 302 and/or smart carts 320 used by different users. For example, an entry noting that bananas are now available at a particular location within particular retail premises might not be made until 3 distinct users (or their systems) have reported that availability. In some embodiments, the entries of the repository 344 store a description of a particular condition (e.g., the availability of a particular item at a particular location within particular premises) in association with other data, such as the day(s), time(s), and user(s) that submitted the environmental data about the condition.

The shopping route module 250 additionally includes a candidate route generation module 350 that generates a set of possible routes that a picker could use to obtain the desired items. That is, given a particular set of desired items (e.g., the items of a particular customer's basket, or the union of the items of the baskets of multiple customers for whom the picker is shopping), the candidate route generation module 350 generates possible routes that may be used to obtain those items (e.g., all of the items, or—in some cases such as known unavailability of certain items-fewer than all of the items). In some embodiments, the candidate route generation module 350 generates the candidate routes using a graph-based algorithm, where the layout of the particular retail premises is modeled as a graph of nodes representing different locations within the premises and edges between those nodes representing a measure of difficulty in moving from one node to another (e.g., an expected measure of time). For example, a weighted minimal spanning tree algorithm could be employed, where the nodes corresponding to locations of the desired items must be included within the minimal spanning tree, and the route candidate is the route that traverses that minimal spanning tree. Different candidate routes could be generated based on different predictions about the various measures of difficult in moving between different nodes in the graph (e.g., the assumption that applicable inferences in the premises conditions 344-such as a spill in a particular aisle—are correct, or a historically-based prediction that in-premises traffic typically slows by 30% at the desired shopping time at the particular retail premises in question).

The shopping route module 250 further includes a picking time module 352 that estimates a measure of difficulty (e.g., the amount of time required) to obtain a given item, starting at a given location within the current retail premises 310, under given environmental conditions. In some embodiments, the picking time module 352 applies a previously trained machine-learned model that takes the given starting location, a location(s) of the given item, and a set of environmental conditions, as input features and outputs a time prediction. In such embodiments, the machine-learned models of the picking time modules 352 may be retrained based on subsequent picking time data obtained from the picker client devices 110 (e.g., that it took 20% longer than expected to obtain a particular item). In other embodiments, the picking time module 352 estimates the measure of difficulty using a weighted shortest path graph algorithm on the same graph discussed above with respect to the candidate route generation module 350, starting from the given starting location and ending at the location of the given item.

The shopping route module 250 further includes a simulation module 342 that simulates the use of each of the candidate routes and estimates a total degree of difficulty (e.g., a total amount of time) of that route. In one or more embodiments, the simulation module 342 uses the picking time module 352 to estimate the degree of difficulty in obtaining each of the items along the candidate route (e.g., 30 seconds to go from the entry of the store to the “organic bananas” item, 20 seconds from the “organic bananas” item to the “packaged Asian salad” item, 32 seconds from the “packaged Asian salad” item to the “19 CRIMES red wine” item, and so forth). The simulation evaluates the degree of difficulty according to the environmental conditions expected at the time of shopping, passing those conditions as input to the picking time module 352 when evaluating the degree of difficulty for each item on the route. In some embodiments, the simulation module 342 simply assumes that the conditions currently listed in the premises conditions 344 will not change; in other embodiments the simulation module 342 first adjusts the values of current premises conditions 344 to match conditions expected at the time of the shopping before providing those conditions as input to the picking time module 352. (For example, the degree of difficulty could be estimated at the time that a picker is assigned to handle the order of a customer, and the expected environmental conditions could be adjusted to account for the fact that the expected shopping time will be an hour later, at which point the congestion in the store will be expected to increase relative to the current level.)

In some embodiments, the simulation module 342 continuously re-calculates its estimates in real time as the picker picks items, rather than pre-computing the entire route. For example, the simulation module 342 could re-simulate the various possible routes after the first item is picked, after the second item is picked, etc. This approach permits accounting for new conditions that arise (and are noted and reflected in the premises conditions repository 344) after any initial simulations. In these embodiments, the simulation module 342 uses the candidate route generation module 350 to re-compute the possible candidate routes from the current point (e.g., after the picker has already obtained some subset of the desired items), only routing to the items not already obtained.

The output of the simulation module 342 is the set of candidate routes (e.g., all candidate routes originally computed, or only the routes from the latest point), along with an associated measure of difficulty (e.g., total time) for each. The shopping route module 250 may then select the optimal candidate route, such as the candidate route with the shorted expected total time to complete, and send an indicator of the route to the picker for use (e.g., to the application 302 on the picker client device 110, and/or to the smart cart 320 being used by the picker). Information about this selected optimized route can then be displayed to the picker, such as by graphically showing the route through the store, along with time estimates.

In some embodiments, the candidate routes are associated with scores that are calculated based not only on the associated measure of difficulty, but also based on other factors related to achieving other objectives. For example, in some embodiments, when the user is a non-picker customer, the routes are scored based on a combination of the measure of difficulty of the route and the degree to which it passed by additional promotional items in which the user may be interested.

Although components are illustrated as being part of particular systems in the environment of FIG. 3, in other embodiments the components could be partitioned differently across the systems, or not be present at all. For example, depending on the capabilities of the picker client device 110 and/or the smart cart, functionality illustrated in FIG. 3 as being part of the online concierge system may be performed instead on the device 110/cart 320. For instance, in some embodiments the inference module 342 is part of the application 302 of the picker client device 110, rather than being located within the shopping route module 250 of the online concierge system 140, or portions of their functionality are split across the device 110 and the module 250. Many such variations would be envisioned by one of skill in the art.

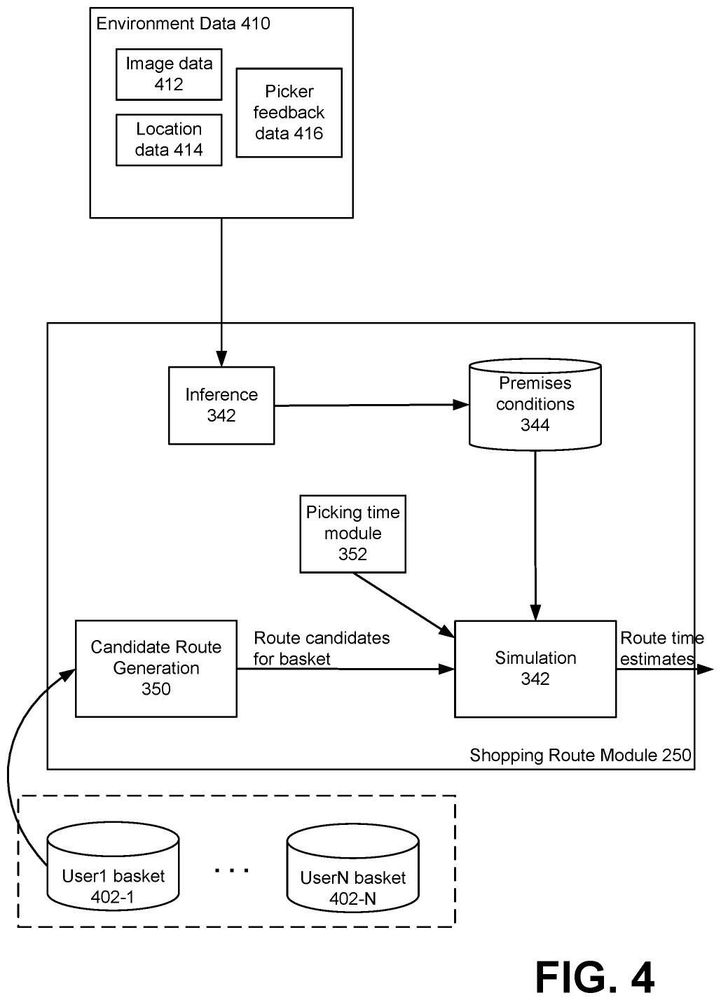

FIG. 4 is a data flow diagram illustrating the data, and transformations of data, involved in determining estimated degrees of difficulty (e.g., time estimates) of the various candidate routes, according to one or more embodiments.

Environment data 410 is provided to the inference module 342. Such environment data may include image data 412 (such as that obtained by the cameras of the smart carts 320), location data 414 (such as that obtained by use of the wireless receivers 326 of the smart carts), and feedback data 416 manually provided by various pickers. The inference model 342 makes inferences about current environmental conditions based on the environmental data and updates the premises conditions repository 344 according to those inferences.

Separately, when determining the best routes for a picker to use for the picker's shopping, the items for which the picker will be shopping (e.g., the items of a particular customer's basket, such as the basket 402-1 depicted in FIG. 4) are provided as input to the candidate route generation module 350, which generates a set of candidate routes for efficiently obtaining those items. The candidate routes are provided as input to the simulation model 342. The simulation module 342 uses the current premises conditions 344, as well as the picking time module 352, to compute estimates of degrees of difficulty of the candidate routes. The simulation module may also modify the premises conditions 344 to reflect expected future conditions at the time of shopping before performing its computations.

As noted above, the data flow may vary in different embodiments. For example, the candidate routes could be repeatedly re-generated, and the simulation module 342 repeatedly used to estimate degrees of route difficulty, in real time for remaining items as the picker proceeds to obtain items.

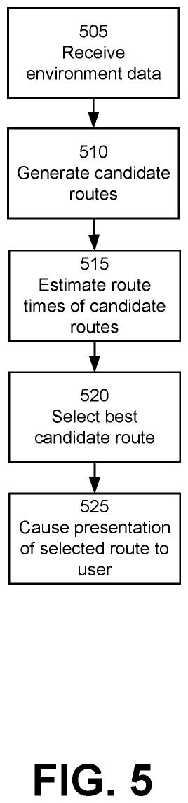

FIG. 5 is a flowchart of steps for selecting optimized shopping routes, according to some embodiments. Alternative embodiments may include more, fewer, or different steps from those illustrated in FIG. 5, and the steps may be performed in a different order from that illustrated in FIG. 5. These steps may be performed by an online concierge system (e.g., online concierge system 140, such as via the shopping route module 250). Additionally, each of these steps may be performed automatically by the online concierge system without human intervention.

In step 505, environment data is received. The environment data may include (for example) the image data 412, location data 414, and picker feedback data 416 of FIG. 4, and may be provided by entities such as the application 302 of the picker client device 110 and/or the smart carts 320 on the retailer premises 310. The environment data may be received from multiple devices 110/carts 320, thereby crowdsourcing the data.

In step 510, candidate routes are generated, as discussed above with respect to the candidate route generation module 350.

In step 515, route times (one measure of route difficulty) are calculated for the various candidate routes, as discussed above with respect to the simulation module 342.

In step 520, the best candidate route is selected. In some embodiments, the “best” route is that with the lowest estimated route time.

In step 525, the selected route is caused to be presented to the user (e.g., the picker). For example, the shopping route module 250 could send data describing the selected route to the application 302 and/or to the smart cart 320, which in turn display information about the selected route to the user.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method performed by a computer system comprising a processor and a computer-readable medium, the method comprising:
receiving environment data associated with a retailer's premises;
inferring, based on the received environment data, current conditions at the retailer's premises;
for a basket of items associated with a user, generating a plurality of candidate routes through the retailer's premises passing by each of at least a plurality of the items in the basket;
estimating, for each of the plurality of candidate routes using one or more picking time modules and the inferred current conditions at the retailer's premises, a route time to obtain items of the basket;
selecting one of the plurality of candidate routes having a lowest estimated route time;
causing a user interface of a client device of the user associated with the basket to display information about the selected candidate route;
after the selecting of one of the plurality of candidate routes, receiving additional environment data associated with the retailer's premises from a user other than the user associated with the basket;
selecting a second candidate route having a least estimated route time according at least in part to the additional environment data; and
causing the user interface to display information about the second selected candidate route.

2. The method of claim 1, wherein the environment data is obtained from a plurality of different devices of a plurality of different users.

3. The method of claim 1, wherein receiving the environment data comprises receiving location data representing a location of the user.

4. The method of claim 1, wherein receiving the environment data comprises receiving camera data obtained from a camera of at least one of: the client device of the user, or a smart cart used by the user on the retailer's premises.

5. The method of claim 1, wherein receiving the environment data comprises receiving user comments data specified by the user within an application on the client device.

6. The method of claim 5, wherein receiving the user comments data comprises receiving comments indicating a location of an obstruction within the retailer's premises, or an alternate location of an item within the retailer's premises.

7. The method of claim 1, wherein the picking time modules:
take, as input, a current location of the user and a location of an item in the basket, and
output an estimated time to obtain the item.

8. The method of claim 1, wherein machine-learned models used by the picking time modules are retrained responsive to obtaining additional data regarding how long it took the user to obtain the items in the basket.

9. A computer system comprising:
a computer processor; and
a computer-readable medium storing instructions that when executed by the computer processor perform actions comprising:
receiving environment data associated with a retailer's premises;
inferring, based on the received environment data, current conditions at the retailer's premises;
for a basket of items associated with a user, generating a plurality of candidate routes through the retailer's premises passing by each of at least a plurality of the items in the basket;
estimating, for each of the plurality of candidate routes using one or more picking time modules and the inferred current conditions at the retailer's premises,
a route time to obtain items of the basket;
selecting one of the plurality of candidate routes having a lowest estimated route time;
causing a user interface of a client device of the user associated with the basket to display information about the selected candidate route;
after the selecting of one of the plurality of candidate routes, receiving additional environment data associated with the retailer's premises from a user other than the user associated with the basket;
selecting a second candidate route having a least estimated route time according at least in part to the additional environment data; and
causing the user interface to display information about the second selected candidate route.

10. The computer system of claim 9, wherein the environment data is obtained from a plurality of different devices of a plurality of different users.

11. The computer system of claim 9, wherein receiving the environment data comprises receiving location data representing a location of the user.

12. The computer system of claim 9, wherein receiving the environment data comprises receiving camera data obtained from a camera of at least one of: the client device of the user, or a smart cart used by the user on the retailer's premises.

13. The computer system of claim 9, wherein receiving the environment data comprises receiving user comments data specified by the user within an application on the client device.

14. The computer system of claim 13, wherein receiving the user comments data comprises receiving comments indicating a location of an obstruction within the retailer's premises, or an alternate location of an item within the retailer's premises.

15. The computer system of claim 9, wherein the picking time modules:
take, as input, a current location of the user and a location of an item in the basket, and
output an estimated time to obtain the item.

16. The computer system of claim 9, wherein machine-learned models used by the picking time modules are retrained responsive to obtaining additional data regarding how long it took the user to obtain the items in the basket.

17. A non-transitory computer-readable medium storing instructions that when executed by a computer processor perform actions comprising:
receiving environment data associated with a retailer's premises;
inferring, based on the received environment data, current conditions at the retailer's premises;
for a basket of items associated with a user, generating a plurality of candidate routes through the retailer's premises passing by each of at least a plurality of the items in the basket;
estimating, for each of the plurality of candidate routes using one or more picking time modules and the inferred current conditions at the retailer's premises, a route time to obtain items of the basket;
selecting one of the plurality of candidate routes having a lowest estimated route time;
causing a user interface of a client device of the user associated with the basket to display information about the selected candidate route;
after the selecting of one of the plurality of candidate routes, receiving additional environment data associated with the retailer's premises from a user other than the user associated with the basket;
selecting a second candidate route having a least estimated route time according at least in part to the additional environment data; and
causing the user interface to display information about the second selected candidate route.

18. The non-transitory computer-readable medium of claim 17, wherein the environment data is obtained from a plurality of different devices of a plurality of different users.

19. The non-transitory computer-readable medium of claim 17, wherein the picking time modules:
take, as input, a current location of the user and a location of an item in the basket, and
output an estimated time to obtain the item.

20. The non-transitory computer-readable medium of claim 17, wherein machine-learned models used by the picking time modules are retrained responsive to obtaining additional data regarding how long it took the user to obtain the items in the basket.
